(19) United States
(12) Patent Application Publication
(10) Pub. No.: US 2026/0037551 A1
(43) Pub. Date: Feb. 5, 2026

(54) METHOD AND APPARATUS FOR PERFORMING DOCUMENT SPLITTING

(71) Applicant: Emtelligent Software Ltd., Vancouver (CA)

(72) Inventors: Nishant KAMBHATLA, Vancouver (CA); Anoop Dipesh SARKAR, Vancouver (CA); Timothy William O'CONNELL, Vancouver (CA)

(21) Appl. No.: 19/264,742

(22) Filed: Jul. 9, 2025

Related U.S. Application Data
(60) Provisional application No. 63/677,354, filed on Jul. 30, 2024.

(51) Int. Cl. G06F 16/31; G06V 30/418

(52) U.S. Cl. CPC G06F 16/31; G06V 30/418

(57) ABSTRACT

The present disclosure provides methods and apparatuses for document splitting on a combined document file that includes, for each page of the combined document file, generating an image file that includes the contents of the page, generating a sequence of overlapping sets of image files, each set including N image files, inputting each set of N image files to a multimodal vision-language model (VLM) engine to determine whether the N image files in the set belong to a same document or to different documents based on the visual features of the image files included in the set, for each set, receiving an output that indicates whether the N image files belong to the same document or to different documents, and generating an index that correlates each page of the combined document file to a corresponding one of the one or more constituent documents based on the outputs.

### FIELD

The present disclosure relates generally to performing document splitting.

### BACKGROUND

Electronic record keeping generally includes databases of documents. One such example is medical record systems in which the type of documentation include in medical record documents. In medical records contexts, data may shared between health providers, such as doctors and hospitals, and insurers via, for example, an “attending physician statement” (APS) documents. An APS document may be a large, combined document that contains multiple individual constituent documents. Combined documents files may be in, for example, a portable document format (PDF) or a tagged image file format (TIF).

These single combined document files may be up to 800 or more pages long, and may comprise hundreds of individual constituent documents.

The combined document files may be used by humans to search through the contents of the combined document for specific pieces of clinical information, which is a very laborious and tedious process.

Document indexing is the process of creating a structured and searchable representation of a collection of documents. The primary goal of document indexing is to make it easier and faster to retrieve relevant information from a large volume of documents. Document indexing is crucial in various fields, including libraries, information retrieval systems, legal document management, and digital content management, where large volumes of documents need to be organized.

Document indexing of a combined document file may include document splitting. Document splitting may refer to separating or splitting scanned pages of individual combined documents from, for example, a large PDF to determine the constituent documents that make up the combined document in order to segment the content of the constituent document file.

Performing document splitting manually is a time-consuming process. A challenge with performing document splitting computationally is determining with accuracy and reliability when one constituent document ends the next begins.

Improvements in performing document splitting are desired.

### SUMMARY

According to one aspect of an embodiment, the present disclosure provides a method for performing document splitting on a combined document file, the method including receiving the combined document file comprising two or more pages that correspond to one or more constituent documents, for each page of the combined document file, generating an image file that includes the contents of the page, generating a sequence of overlapping sets of image files, each set including N image files, inputting each set of N image files to a multimodal vision-language model (VLM) engine with a prompt that instructs the VLM engine to determine whether the N image files in the set belong to a same document or to different documents based on the visual features of the image files included in the set, for each set of N image files, receiving from the VLM engine an output that indicates whether the N image files belong to the same document or to different documents, generating an index that correlates each page of the combined document file to a corresponding one of the one or more constituent documents based on the outputs from the VLM engine associated with the overlapping sets.

In an example, the prompt instructs the VLM engine to generate a summary of each image in the set of N images prior to determining whether the N images in the set belong to a same document or to different documents, and instructs the VLM engine to determine whether the N images in the set belong to the same document or to different documents based on the summary, and receiving the output from the VLM engine includes receiving, for each set of N images, the summary of each image in the set.

In an example, the prompt instructs the VLM engine to generate reasons for the determination whether the N images in the set belong to the same document or to different documents, and receiving the output from the VLM engine includes receiving, for each set of N images, the reasons.

In an example, the prompt instructs the VLM engine to determine whether the N images in the set belong to the same document or to different documents based on text content of the images of the set.

In an example, the prompt instructs the VLM engine to focus on the visual features of the image more than on the text content.

In an example, the prompt instructs the VLM engine to focus on one or more identifiers included in the text content.

In an example, the prompt instructs the VLM engine to focus on the visual features of one or more of font-style, formatting, style of writing, or table format.

In an example, the method further includes grouping the sets of N images into sequential, overlapping batches, each batch including K sets of N images, and wherein inputting each set of N images to the VLM engine comprises iteratively inputting each batch of K sets.

In an example, K is greater than 1 and less than or equal to 10.

In an example, N=2, and the sequential sets overlap by one (1) image.

According to another aspect of an embodiment, the present disclosure provides an apparatus for performing document splitting on a combined document file, the apparatus includes at least one processor, and at least one memory storing instructions, wherein when the instructions are executed by the at least one processor, cause the apparatus to receive the combined document file comprising two or more pages that correspond to one or more constituent documents, for each page of the combined document file, generate an image file that includes the contents of the page, generate a sequence of overlapping sets of image files, each set including N image files, input each set of N image files to a multimodal vision-language model (VLM) engine with a prompt that instructs the VLM engine to determine whether the N image files in the set belong to a same document or to different documents based on the visual features of the image files included in the set, for each set of N image files, receive from the VLM engine an output that indicates whether the N image files belong to the same document or to different documents, generate an index that correlates each page of the combined document file to a corresponding one of the one or more constituent documents based on the outputs from the VLM engine associated with the overlapping sets.

In an example, the prompt instructs the VLM engine to generate a summary of each image in the set of N images prior to determining whether the N images in the set belong to a same document or to different documents, and instructs the VLM engine to determine whether the N images in the set belong to the same document or to different documents based on the summary, and the instructions, when executed by the at least one processor, cause the apparatus to receive the output from the VLM engine include instructions that, when executed by the at least one processor, cause the apparatus to receive, for each set of N images, the summary of each image in the set.

In an example, the prompt instructs the VLM engine to generate reasons for the determination whether the N images in the set belong to the same document or to different documents, and the instructions, when executed by the at least one processor, cause the apparatus to receive the output from the VLM engine include the instructions that, when executed by the at least one processor, cause the apparatus to receive, for each set of N images, the reasons.

In an example, the prompt instructs the VLM engine to determine whether the N images in the set belong to the same document or to different documents based on text content of the images of the set.

In an example, the prompt instructs the VLM engine to focus on the visual features of the image more than on the text content.

In an example, the prompt instructs the VLM engine to focus on one or more identifiers included in the text content.

In an example, the prompt instructs the VLM engine to focus on the visual features of one or more of font-style, formatting, style of writing, or table format.

In an example, the instructions, when executed by the at least one processor, further cause the apparatus to group the sets of N images into sequential, overlapping batches, each batch including K sets of N images, and wherein the instructions, when executed by the at least one processor, cause the apparatus to input each set of N images to the VLM engine include instructions that, when executed by the at least one processor, cause the apparatus to iteratively inputting each batch of K sets.

In an example, K is greater than 1 and less than or equal to 10.

In an example, N=2, and the sequential sets overlap by one (1) image.

According to another aspect of an embodiment, the present disclosure provides a non-transitory computer readable medium having stored thereon instructions that, when the instructions are executed by at least one processor, cause the at least one processor to receive the combined document file comprising two or more pages that correspond to one or more constituent documents, for each page of the combined document file, generate an image file that includes the contents of the page, generate a sequence of overlapping sets of image files, each set including N image files, input each set of N image files to a multimodal vision-language model (VLM) engine with a prompt that instructs the VLM engine to determine whether the N image files in the set belong to a same document or to different documents based on the visual features of the image files included in the set, for each set of N image files, receive from the VLM engine an output that indicates whether the N image files belong to the same document or to different documents, generate an index that correlates each page of the combined document file to a corresponding one of the one or more constituent documents based on the outputs from the VLM engine associated with the overlapping sets.

In an example, the prompt instructs the VLM engine to generate a summary of each image in the set of N images prior to determining whether the N images in the set belong to a same document or to different documents, and instructs the VLM engine to determine whether the N images in the set belong to the same document or to different documents based on the summary, and the instructions, when executed by the at least one processor, cause the at least one processor to receive the output from the VLM engine include instructions that, when executed by the at least one processor, cause the at least one processor to receive, for each set of N images, the summary of each image in the set.

In an example, the prompt instructs the VLM engine to generate reasons for the determination whether the N images in the set belong to the same document or to different documents, and the instructions, when executed by the at least one processor, cause the at least one processor to receive the output from the VLM engine include the instructions that, when executed by the at least one processor, cause the at least one processor to receive, for each set of N images, the reasons.

In an example, the prompt instructs the VLM engine to determine whether the N images in the set belong to the same document or to different documents based on text content of the images of the set.

In an example, the prompt instructs the VLM engine to focus on the visual features of the image more than on the text content.

In an example, the prompt instructs the VLM engine to focus on one or more identifiers included in the text content.

In an example, the prompt instructs the VLM engine to focus on the visual features of one or more of font-style, formatting, style of writing, or table format.

In an example, the instructions, when executed by the at least one processor, further cause the at least one processor to group the sets of N images into sequential, overlapping batches, each batch including K sets of N images, and wherein the instructions, when executed by the at least one processor, cause the at least one processor to input each set of N images to the VLM engine include instructions that, when executed by the at least one processor, cause the at least one processor to iteratively inputting each batch of K sets.

In an example, K is greater than 1 and less than or equal to 10.

In an example, N=2, and the sequential sets overlap by one (1) image.

The term “non-transitory,” as used herein, is a limitation of the medium itself (i.e., tangible, not a signal) as opposed to a limitation on data storage persistency (e.g., RAM vs. ROM).

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic diagram showing a system in accordance with an aspect of an embodiment.

FIG. 2 is a flowchart showing a method in accordance with an example embodiment.

FIG. 3 is a schematic diagram illustrating an example aspect of the method in accordance with an example embodiment.

FIG. 4 is a schematic diagram illustrating an example index generating in accordance with the method in accordance with an example embodiment.

FIG. 5 is a schematic diagram showing components of one or more of the example embodiments.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

Generally, the present disclosure provides a method for performing document splitting of a combined document that includes one or more constituent documents. In the present disclosure, “document splitting” refers to a process for determining boundaries between constituent documents of a combined document and may, in some examples, include separating or segregating one or more of the constituent documents from the combined document based on the determined boundaries. Document splitting may be performed as a preliminary step in the broader process of document indexing. For example, before indexing, a combined documents may be prepared by, for example, determining the separations between the individual constituent documents included in the combined document. Determining the separations may be useful for ensuring, for example, that each constituent document is complete and properly formatted prior to performing document indexing on the constituent documents. By determining the separation of the pages of the combined document into individual documents enables segmentation of the content of the combined document into the constituent documents. Segmentation of the combined document into the constituent documents may be desired to more accurate index the combined document by facilitating each constituent document being indexed individually rather than as part of a larger, mixed collection in the combined document.

In the present disclosure, document splitting is performed by decomposing the constituent documents, then performing analysis on the decomposed parts to determine boundaries between the constituent documents, then generating an index that correlates the pages of the combined document to constituent documents, which index may be utilized to, for example, later split the combined document into the constituent document and perform further document indexing on the constituent documents. The decomposition of the combined document may be performed by generating an image file for each page of the combined document, generating a sequence of overlapping sets of N image files, and inputting each set of N image files into multimodal vision language model (VLM) engine with instructions to cause the VLM engine to determine whether the N images belong to the same document based on, at least, the visual features of the image files in the set. The instructions may further instruct the VLM engine to prepare a summary of the image files before making the determination, and/or provide reasons for the determination that was made in order to cause the VLM engine to make the determination utilizing a chain-of-thought prompting.

Although the present disclosure describes example embodiments in terms of performing document splitting of electronic records in a medical context, this is for illustrative purposes only and it is understood that the same concepts described herein can be applied to electronic records in any other context including, for example, legal, accounting, financial, business, and so forth.

Conventional approaches to computationally performing document splitting may utilize machine learning, such as, for example, a large language model (LLM) engine that attempts to identify the different constituent documents in a combined document based on analyzing the text content of the document. As noted previously, an issue with conventional document splitting is the results they produce can be inaccurate, and, further, do not provide any way to check the reliability of the splitting that is performed.

Various algorithmic strategies have conventionally been employed for document splitting. Machine learning models, particularly those based on natural language processing (NLP), have been employed. These models can be trained on annotated datasets to recognize patterns and indicators that signify the transition between different documents. For instance, changes in topic, formatting cues, or specific keywords often serve as reliable indicators. Unsupervised learning techniques such as clustering have been utilized to group similar sections of text together, which groups are used to identify boundaries between documents without the need for pre-labeled training data. Another approach involves the use of rule-based systems, which may apply a set of predefined rules derived from the predetermined structure and formatting common in certain types of documents being indexed such as, for example, forms and other documents that follow a particular template. These rules can be as simple as recognizing page numbers or section headings, or more complex, involving the analysis of linguistic features such as sentence structure and vocabulary usage. But these methods are tailored to textual data and have limited application when dealing with scanned documents, particularly scanned documents that include a variety of different constituent document types.

Document splitting becomes particularly challenging utilizing the previously described conventional approaches when dealing with scanned multipage documents that might contain several individual documents merged into one file. Unlike digital texts, scanned documents introduce complexities such as variations in page layout, presence of non-textual elements (like images and signatures), and inconsistencies in text due to scanning quality. These factors necessitate a more sophisticated approach than utilized in the conventional approaches outlined above to ensure accuracy of the resulting document splitting.

As described in the more detail below, the present disclose provides document splitting that utilizes and accounts for visual features, and in some embodiments together with textual features, to segment combined documents with increased accuracy relative to conventional approaches, particularly in the context of the scanned multipage documents that include multiple individual constituent document. The integration of visual features, together with textual features in some examples, utilizes a multimodal approach, where data from different sources, e.g., text, formatting, and image data, may be fused into a cohesive analysis framework.

Embodiments of the present disclosure generate overlapping sets of image files, in which each page of the combined document corresponds to a respective one of the image files, then iteratively providing the sets of image files to a VLM engine together with a prompt that instructs the VLM engine to determine whether the image files of the set belong to the same document or different document based on visual features. The visual features may include any suitable visual features such as, for example, any of font-style, formatting, style of writing, background colours, header and/or footer features, images, and/or table format included in the image files. The sets of overlapping image files may be provided to the VLM in bundles in order to provide the VLM engine with additional information to make the determination. The instructions may also instruct the VLM engine to utilize the text content of the pages, in addition to the visual features, when determining whether the pages of the set belong to the same document or different document.

By providing pages of the documents in overlapping sets of pages and instructing the VLM engine to determine whether the pages belong to the same document or different documents, the inputs to the VLM engine are constrained compared to providing the entire combined document, enabling the VLM engine to perform deeper analysis of the pages of the set when determining whether the pages belong to the same document or different documents.

Further, different documents often appear visually different, in terms of, for example, layout, font style and size, formatting of tables, and the like. Instructing the VLM engine to utilize the visual features, or to focus more on the visual features than on the text content, may provide a more intuitive process for determining whether pages of a set belong to same document or different documents, and may result in more reliable determinations compared to conventional processes that rely only the text content. For example, the contents of the constituent documents in a combined document will generally relate to the subject matter, such as for example, medical information in the context of medical records, which may make identifying the constituent documents challenging when relying on the text content of the combined document. Utilizing visual features, alone or with text content in some examples, provide important information that is relevant to determine separation between constituent documents that conventional, purely text-based, approaches fail to leverage.

Other advantages of the present disclosure will be apparent in the following description of the embodiments.

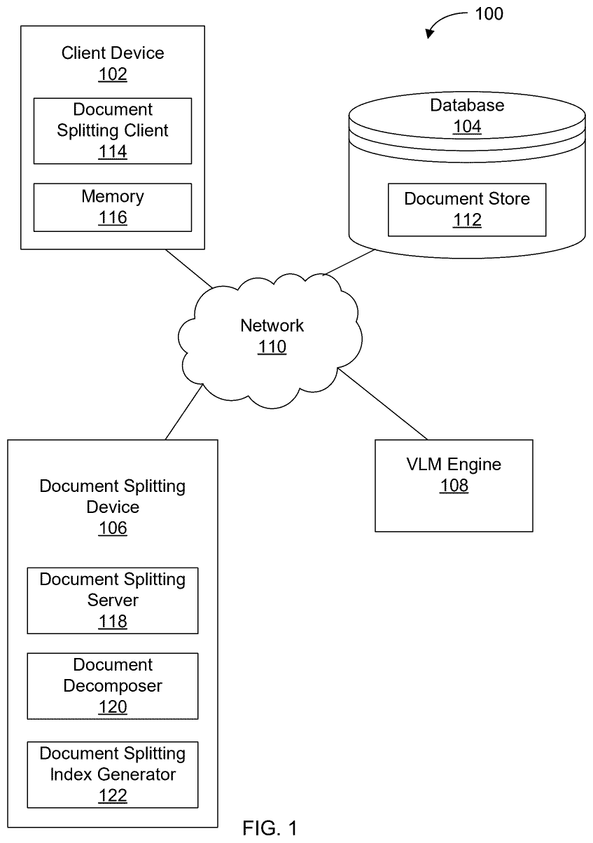

Referring now to FIG. 1, schematic representation of an example system 100 for document splitting is shown. The example system 100 includes a client device 102, a database 104, a document splitting device 106, and a multimodal vision language model (VLM) engine 108 that communicate with each other via a network 110. The network 110 may be any suitable wired or wireless network, or combination of wired and wireless networks including, for example, a local area network (LAN), or a wide area network (WAN), or a combination thereof.

The database 104 may include a document store 112 that stores electronic documents. The document store 112 may be, for example, part of an electronic record keeping system, or any other suitable document management system. The data store may stores records for a particular context such as, for example, a medical context, a legal context, a financial context, a business context, and the like. The electronic documents may be combined documents, which in the present disclosure refer to electronic documents that include one or more constituent documents that are, for example, concatenated together into a single electronic document file. For example, in a medical context, a combined document may include all of the constituent documents that are included in, for example, a single patient's medical record file. The combined document file may be generated by, for example, scanning all of the constituent documents of a patient's medical record file together to avoid the time required to scan each individual constituent document separately.

The client device 102 may include a document splitting client 114 that may be utilized to communicate with the document splitting device 106 in order to initiate document splitting processes on a combined document. The document splitting client 114 may include a graphical user interface that is displayed on a display (not shown) of the client device 102 to enable the user of the client device to communicate with the document splitting device 106 and initiate document splitting processes on a combined document.

The document splitting client 114 may also enable one or more input documents to be included with a command to the document splitting device 106 that initiates a document splitting process on the one or more input documents. The input documents may be stored in a memory 116 of the client device, in one or more remote databases, such as the document store 112 of the database 104. The document splitting client 114 may retrieve copies of the input combined documents from the memory 116 or the database 104 and provide the copies of the input combined documents to the document splitting device 106 together with a command to cause the document splitting device 106 to initiate a document splitting process on the one or more input combined documents. Alternatively, the document splitting client 114 may include references or pointers to where the input combined documents are stored when sending the command to the document splitting device 106 to initiate document splitting of the input documents.

The document splitting client 114 may be, for example, an application that is stored and executed at the client device 102, or may be a web-based application hosted on a server that is accessed through a web-browser executed at the client device 102.

The example document splitting device 106 shown in FIG. 1 includes a document splitting server 118 that is configured to interface with the document splitting client 114 at the client device 102. The document splitting server 118 may provide the graphical user interface that may be displayed at the client device 102 in some embodiments. The document splitting server 118 may host a web-based application that may be accessed when the document splitting client 114 is implemented as a web-based application, as previously described.

The document splitting server 118 may receive a command from the document splitting client 114 that causes the document splitting server 118 to initiate a document splitting process at the document splitting device 106 as described in more detail below.

The document splitting server 118 may receive the command from the document splitting client 114 of the client device 102 together with one or more input documents. As described previously, the document splitting server 118 may receive copies of the one or more input combined documents together with the command. Alternatively, or additionally, the document splitting server 118 may receive indications of the one or more input combined documents, such as, for example, references or pointers to the one or more input combined documents stored in the memory 116 or the database 104, in which case the document splitting server 118 may retrieve copies of the one or more input combined documents utilizing the indications, or in a memory (not shown) of the document splitting device 106.

In other embodiments, a user may provide the command directly to the document splitting device 106 utilizing a user input device (not shown) of the document splitting device 106. For example, a display (not shown) of the document splitting device 106 may display a graphical user interface that the user may interact with, via a user input device (not shown), to input a command to initiate a document splitting process and select one or more input combined document associated with the command.

The document splitting server 118 provides the combined document to a document decomposer 120. The document decomposer 120 may be configured to generate a sequence of overlapping sets of pages of the combined document, each set including N pages where, in one particular example, N=2. The document decomposer 120 may be configured to input the sets of images to the VLM engine 108 with instructions to determine whether the pages in the set belong to a same document or to different documents based on the visual features of the pages included in the set. In order to generate the sets, the document decomposer 120 may first generate, for each page of the combined document, a corresponding image file, then group the image files into the overlapping sets as described in more detail below. The sets may be provided to the VLM engine 108 in bundles that include K sets of pages where, in a particular example, K=3, 4, or 5. In other examples, K may be greater than 1 but less than or equal to 10. In general, K is a hyperparameter, meaning that it is a setting or value used to control the behaviour of a machine learning model. The value of K may be chosen to be between a minimum value of 1 and maximum value of X−1 where X is the maximum number of image inputs that can be supported by the VLM engine 108 that is being utilized.

As described in more detail below, the instructions provided to the VLM engine 108 may additionally include instructions to first prepare a summary of each page, then make the determination based on the summary, as well as optionally instructing the VLM engine 108 to provide reasons for its answer, such that the instructions cause the VLM engine 108 to determine whether the pages of the set belong to the same document or different document utilizing a chain-of-thought prompting.

The VLM engine 108 may be any suitable generative model engine that is trained using text and images and that may be utilized to generate text output from image and text input. The VLM engine 108 is configured such that is able to receive sets of N pages and made a determination, based on at least the visual features of the pages, a determination of whether the pages belong to the same document or different document. The VLG engine 108 may, in certain embodiments, be configured to determine a summary of the pages of the sets and make its determination based on the summary, and/or provides reasons for the determination that it makes. In certain embodiments, the VLM engine 108 may be configured to make its determination based on the text content of the pages in addition to the visual features.

The output from the VLM engine 108, which includes the determination for each set of pages as well as, in some embodiments, the summary of each page and the reasons for the determination, is received at the document splitting index generator 122. The document splitting index generator 122 is configured to generate an index based on the output from the VLM engine 108 correlates each page of the combined document file to a corresponding constituent document, as described in more detail below. The generated index may be stored, for example, as metadata associated with the combined document. The generated index may be stored in a memory (not shown) of the document splitting device 106, or in the database 104, either together with or separate from the combined document. The generated index may be transmitted over the network 110 to another device, such as for example the client device 102, in response to an API call.

The generated index may include any information that may be utilized to separate or segregate the combined document into the constituent documents, and may include any suitable format. In an example, the generated index may include, for each constituent document, a list of the pages of the combined document that are included in that constituent document. In examples in which the output from VLM engine 108 includes a summary of the pages, a brief description of each constituent document, based, for example, on the summaries, and/or a category of document associated with each constituent document determined from the summaries, may be included in the index generated by the document splitting index generator 122.

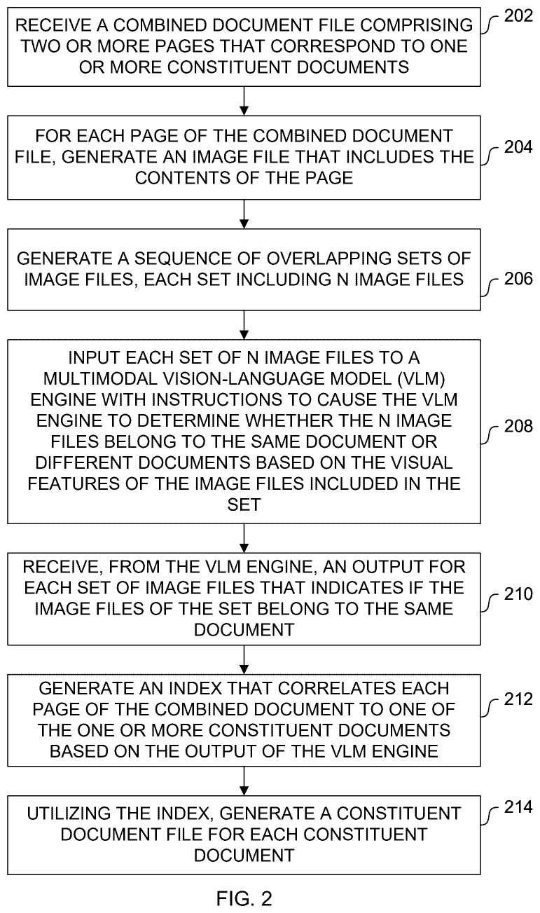

Referring now to FIG. 2, a flow chart showing an example method or process for performing document splitting is shown. The example method or process may be performed by a document splitting device such as, for example, the document splitting device 106 described previously with reference to FIG. 1. The method or process may be performed by one or more processors of the document splitting device that execute computer-readable code stored in a non-transitory memory of the document splitting device, the computer-readable code providing instructions to the one or more processor for performing the method or process.

At 202, a combined document file comprising two or more pages, the pages corresponding to one or more constituent documents is received. The combined document file may be any suitable format including, for example, PDF or TIF. The combined document file may include constituent documents that relate to any subject matter. In an example, the combined document file may include medical records. In other examples, the combined document file may include legal, financial, and/or business records.

The combined document may be received at 202 from, for example, a client device together with a request or command to initiate document splitting on the combined document. In another example, the combined document may be received at 202 by retrieving the combined document from, for example, a memory such as, for example, a memory 116 of a client device 102, a memory (not shown) of the document splitting device 106, or from a database 104. For example, a request or command to initiate data splitting of a combined document may include a pointer to a storage location in a memory at which the combined document is stored, and the document splitting device may retrieve a copy of the combined document in response to receiving the request or command in order to receive the combined document at 202.

At 204, for each page of the combined document, an image file that includes the contents of the page is generated. Any suitable method for generating image files may be utilized, and any suitable image format may be utilized when generating the image files at 204. In an example, the generated image files are portable network graphic (PNG) files. In other examples, the images files may be PDF, TIF, JPEG, BMP, or any other suitable image file type.

At 206, a sequence of overlapping sets of image files are generated such that each set includes N image files. The sets of image files are generated until all of the image files, corresponding to all of the pages of the combined document, are included in at least one set.

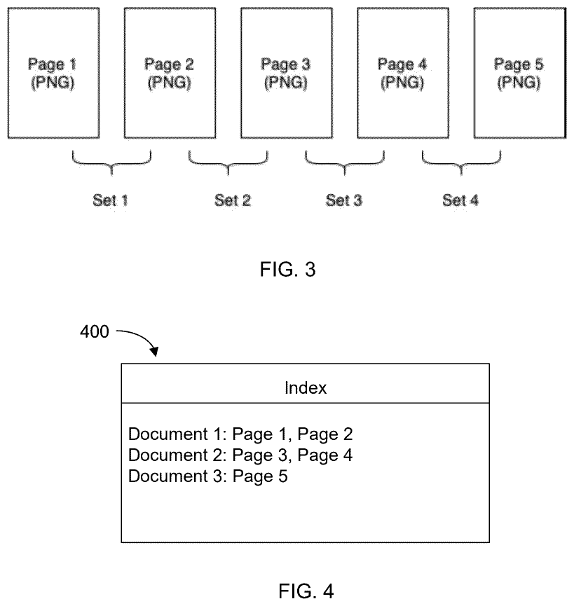

Referring to FIG. 3, an example of the sets that are generated for a combined document having five (5) pages, corresponding to five (5) PNG image files is shown where N=2 and the number of images that overlap between sequential sets is one (1). As shown, four (4) sets of image files are generated as follows: Set 1=[Page 1, Page 2]; Set 2=[Page 2, Page 3]; Set 3=[Page 3, Page 4]; Set 4=[Page 4, Page 5].

In general, when the N=2, the overlap between sets is one, and the combined document includes D pages, then D−1 sets will be generated as follows: [Page 1, Page 2], [Page 2, Page 3], . . . , [Page D−1, Page D].

Although the present examples are described with N=2, in practice N could be greater than 2. However, N=2 may be desired because it enables a simple binary determination by the VLM engine of whether the image files of the set belong to the same document or not, as described in more detail below. In contrast, a simple binary determination may be not be conclusive for N=3 or greater because further analysis may be needed in the even that the determination is that the image files do not belong to the same document to determine which of the three (3) image files belongs to which documents. At 208, each set of N image files is input to a VLM engine with instructions to cause the VLM engine to determine whether the N image files belong to the same document or to different documents based on the visual features of the image files included in the set.

The instructions to base the determination on the visual features may specify that the visual features that the VLM engine is to focus on. The specific visual features may include, for example, one of more of: layout, font-style, formatting, style of writing, or table format.

In addition to including instructions for the VLM engine to base the determination on the visual features, the instructions may also instruct the VLM engine to base the determination on the text content of the image files. In an example, the instructions may specify that the text content that the VLM engine focus on include identifiers included in the image files. For example, the identifiers may include specific textual details such as in, for example, a medical context may include a document identifier, such as a document number and/or form type, a patient identifier, such as name, health number, and/or date of birth, and/or a laboratory identifier, such as a name or address of a laboratory. The VLM engine may be instructed to focus on identifiers in a header and/or footer portion of the image file.

A combination of textual summaries and visual analysis may enable to VLM engine to make a more nuanced and comprehensive understanding of the document structure. Visual features may contribute to each step in the process and may reinforce the chain-of-thought reasoning of some embodiments that instruct the VLM engine to employ chain-of-thought prompting. Alongside textual summaries, visual features such as layout, font style, image presence, and table formats may be analyzed to understand the visual consistency across pages. This may add another layer of summarization, focusing on the visual aspects that might indicate a new section or document. Visual features may provide additional criteria for comparison, beyond the textual content. By evaluating similarities or differences in visual styles, formats, and other visual markers, the VLM engine may make more informed decisions about whether consecutive pages are part of the same document. This may be particularly desired in documents where visual cues are significant indicators of structure, such as clinical reports.

Additionally or alternatively, the instructions provided at 208 may include instructions for the VLM engine to provide a summary or description of each image file prior to making the determination. Instructing the VLM engine to generate summaries may aid the VLM engine's decision-making process by causing the VLM engine to utilize a “chain-of-thought” methodology to arrive at the determination.

The chain-of-thought methodology in artificial intelligence and machine learning involves breaking down a complex problem into smaller, more manageable parts and sequentially addressing each part to arrive at a final decision or solution. This approach may be characterized by its step-by-step reasoning, which mimics a form of human-like problem-solving process. Page summaries may serve as an intermediary step that transforms raw data into a more manageable and analyzable format, thereby enhancing the VLM engine's performance in identifying document boundaries with greater accuracy and reliability.

Page summaries may distill the essence of each page by filtering out irrelevant details and highlighting the most critical content. This condensed form of information may make it easier for the VLM engine to process and compare different pages. Further, by summarizing pages, the VLM engine may gain a clearer, more standardized basis for comparison for image files in order to determine whether the image files belong to the same document or not. This may be particularly important when assessing the similarity between consecutive pages to determine document boundaries. Summaries may provide a uniform format for comparison, focusing on key features such as, for example, themes, topics, or specific details that indicate continuity or transition between sections. Further still, summaries may help the VLM engine grasp the broader context of the document by providing a snapshot of each page's content. Understanding the context may facilitate the VLM engine recognizing patterns, such as recurring themes or subjects, which may inform the VLM engine's understanding of how pages are grouped within the document.

In the example introduced above with reference to FIG. 3, the below example summaries generated by VLM engine for pages 3 and 4 are implicitly juxtaposed during the summarization and found to be contextually related, which may help the VLM engine more easily make the determination that page 3 and 4 belong to the same constituent document:

Page 3: This page appears to be a laboratory report . . . .

Page 4: This page continues the laboratory report from the previous page . . . .

Additionally or alternatively, the instructions provided at 208 may include instructions for the VLM engine to provide reasons for the determination that is made. The reasons for the VLM engine's decision may be helpful for transparency, which may be helpful for a user to determine how the VLM engine arrived at its determination and how reliable the determination is. Further, the transparency in the reasons may be utilized to, for example, fine the tune the VLM engine by, for example, identifying and adjusting assumptions made by the VLM engine, to provide more accurate determinations in instances where the VLM engine's determination was incorrect.

Causing the VLM engine to provide reasons for its determination may further enhance the chain-of-thought prompting that the VLM engine utilizes, and may result in more accurate determinations. For example, by providing reasons, the VLM engine is forced to better understand the context and content of each constituent document, providing enhanced contextual understanding. This deeper understanding may help the VLM engine more accurately identify the boundaries and characteristics of each constituent document. Additionally, when the VLM engine is forced to articulate its reasoning, it has to verify each step of its logic, which may provide error checking and correction that the VLM engine might not otherwise perform if it is not generating reasons for its determination. This process may cause the VLM engine to catch and correct errors that might have gone unnoticed if the VLM engine were simply providing the determination without explanation. Additionally, the VLM engine being required to provide reasons for its decisions may impose a structured approach to the task, resulting in structured thinking which may cause the VLM engine considers all relevant factors systematically, leading to more accurate and reliable outputs.

Instructing the VLM engine to provide reasoning enhances the accuracy of the determinations by promoting a deeper and more structured engagement with the content, facilitating error detection and correction, and reinforcing logical decision-making processes. This methodical approach leads to a more precise identification and separation of constituent documents within the larger combined document.

In an example, in a document splitting process in which the VLM engine is identifying boundaries between a pathology report and an MRI brain scan report within a combined PDF document, when the VLM engine is instructed to provide reasoning, the VLM engine might analyze the content more thoroughly as follows. When analyzing the pathology report, the VLM engine might recognize keywords, medical terminology, and format specific to pathology reports, such as “specimen,” “histology,” “microscopic examination,” and when analyzing the MRI report, the VLM engine might look for terms like “MRI,” “scan,” “findings,” “imaging,” and anatomical details specific to brain scans. When providing its reasons, the VLM engine might generate the following, for example, for page 1: “The text includes terms like ‘surgical specimen’ and ‘histology,’ indicating this is a pathology report” and for page 3: “The document shifts to terms such as ‘MRI,’ ‘imaging,’ and detailed brain anatomy, suggesting a different type of medical report”. By articulating this reasoning, the VLM engine it correctly identifies and separates the documents based on their specific characteristics.

In an example based on the sets that are illustrated in FIG. 3 are provided in a single bundle of input sets at 208 together with instructions to provide reasons for the determination, the following example output reasons may generated for both Set 2 (Pages 2 and 3) and Set 4 (Pages 4 and 5) indicating that the VLM engine has looked beyond their “expected” context of 2 pages included in these sets and used their respective previous sets (pages 1,2 and 3,4) to arrive at the determination:
Set 2: reason >Page 3 is a laboratory report with test results, which is different in format and content from the order forms on pages 1 and 2.
Set 4: reason >Page 5 contains a single test result for an ANA screen, which is different from the comprehensive laboratory report on pages 3 and 4.

In some examples, the sets may be input to the VLM engine at 208 in batches of K sets at a time. VLM engines operate within a finite, constrained context window, defined by the maximum amount of input they can analyze at a given time, often quantified in terms of tokens for textual content and equivalent measures for images. This limitation inherently restricts the volume of textual and visual information the VLM engine can process in a single instance. The VLM engine sequentially assimilates details from each image and accompanying text to formulate its responses. In an example, a limit of 20 for the VLM engine means that the VLM engine may accommodate no more than 20 image files in a single input. This threshold, denoted as Pₘₐₓ or the maximum number of pages the VLM engine can accept in a single input, directly influences the number K of sets of image files that can be included in a bundle, with the maximum number of sets (Kₘₐₓ) computed as Kₘₐₓ=Pₘₐₓ−1, which in this case equals 19, in the case in which N=2.

However, in practice, including a total number of image files in an input bundle of K sets that approaches the upper limit, Pₘₐₓ, may lead to what's known as context dilution. This phenomenon occurs because the VLM engine's finite capacity is spread across a larger number of inputs, potentially diminishing the VLM engine's capacity to deeply analyze or relate the contents of each image file. The VLM engine may fail to fully appreciate or integrate the richness and nuances of individual image files into the VLM engine's understanding, leading to outputs that are less accurate or insightful. Essentially, the VLM engine's focus becomes too dispersed to maintain a strong grasp on the intricacies of each image file, affecting the coherence and relevance of its outputs. So in the above example, when K=19 sets of input images at provided to the VLM engine, which corresponds to a number of input image files that is at the VLM engine's threshold Pₘₐₓ=20, the VLM engine's accuracy drops and the result may become very stochastic.

Conversely, the number of sets of input image files being limited to a number closer to 1 may lead to what is known as constrained context. In such cases, the VLM engine's perspective is narrowly focused on a minimal set of inputs, which might inhibit the VLM engine from grasping broader context or external references that are crucial for understanding. This tunnel vision effect can render the VLM engine “blind” to vital information that lies outside its immediate input window, thereby impacting its ability to generate well-informed and contextually accurate responses. In essence, with too few inputs, the VLM engine lacks the breadth of context necessary for comprehensive understanding and nuanced output, operating with a myopic view.

In some examples, values of K from 3 to 5 may provide more accurate and reliable output compared to other values of K less than 3 or greater than 5 for which the accuracy drops because of insufficient context, i.e., constrained context, or too much context, i.e., context dilution.

At 210, output from the VLM engine is received for each set of image files that are input to the VLM engine at 208. The output indicates if the image files of the set belong to the same document or not. In an example, the indication included in the output received at 210 may be a binary indication of whether the image files of a set belong to the same document or not such as, for example, a “yes” indication indicating that the images belong to the same document, or a “no” indication indicating that the image files do not belong to the same set.

In examples in which N=2 image files are included in each set, a binary indication would be enough to conclude whether the all of the image files of the set belong to the same document or not.

In other examples in which N>2 image files are included in each set, a binary indication that indicates the image files of the set do not all belong to the same document, a conclusive determination of which documents each image file belongs to cannot be made.

In such examples in which N>2 and the output indicates that the images files do not belong to the same document, the steps outlined previously with reference to 206 to 208 may be performed again for the image files of such sets such that new overlapping sets are regenerated with N=2 at 206, and the regenerated overlapping sets are input into the VLM engine as described at 208.

In this way, the indication included in the output received at 210 for the regenerated sets may be utilized to conclusively determine what documents each of the image files belongs to. This approach may be desirable when, for example, it is known before hand that the constituent documents typically include more than three or more pages.

In this example, regeneration of sets of images with N=2 is performed only when a boundary between constituent documents is detected by an indication in the output at 210 that the image files of a set do not all belong to the same document. This approach may result in a reduced number of sets that are input into the VLM engine overall, resulting in a reduction of computer resources utilized for performing document splitting, particularly when the constituent documents are longer documents.

However, in other examples, including, for example, when the number of pages of the constituent documents are not typically more than a few pages, it may be desirable generate overlapping sets with N=2 at 206 for all image files such that the indication included in the output at 210 may be utilized to conclusively determine which documents each image set belongs to, as described below.

If the input to the VLM 208 includes instructions for the VLM engine to provide a summary of each of the image files and/or to provide reasons for the indication that is included in the output, then the output received at 210 may additionally include the summary of each image file and/or the reasons for the indication such that the output reflects the chain-of-thought prompting utilized by the VLM engine as described previously.

As described previously, in examples in which the input to the VLM 208 includes instructions to utilize the text content of the image files as well as the visual features, then the output received at 210, including the indication and, in some examples, the summary and/or the reasons will be based on the text content in addition to the visual features.

At 212, an index that correlates each page of the combined document to one of the one or more constituent documents is generated based on the output of the VLM engine. The index generated at 212 may include any information that may be utilized to separate or segregate the combined document into the constituent documents. In an example, the generated index may include, for each constituent document, a list of the pages of the combined document that are included in that constituent document.

Generating the index at 212 may be performed by inferring, based on the indications received at 210, the pages at which one constituent document ends the next document begins.

An illustrative example that continues from the example illustrated in FIG. 3 in which a combined document having five (5) pages is utilized to generate four (4) sets of overlapping sets of N=2 image files, Sets 1-4, the output received at 210 includes the binary indications: Set 1: Yes; Set 2: No; Set 3: Yes: Set 4: No.

From the “Yes” indication for Set 1, corresponding to pages 1 and 2, it may be inferred that pages 1 and 2 belong to the same constituent document, which may be labelled “document 1”. From the “No” indication for Set 2, which corresponds to pages 2 and 3, it may be inferred that page 3 belongs to a different constituent document, which may be labelled “document 2”, than “document 1” which page 2 was previously determined to belong to. From the “Yes” indication for Set 3, which corresponds to pages 3 and 4, it may be inferred that page 4 belongs to the same “document 2” that page 3 was previously determined to belonged to. From the “No” indication for Set 4, which corresponds to pages 4 and 5, it may be inferred that page 5 belongs to a different constituent document, which may be labelled “document 3”, than “document 2” which page 4 was previously determined to belong to.

In this manner, and due to the nature of the overlapping sets of image files, the binary indications may be utilized to infer which constituent documents that the pages of the combined document belong to. Based on these inferences, an index may be generated that correlates each page of the combined document to one of the one or more the constituent documents. In FIG. 4, an example of an index 400 is shown for the previously described example in which pages 1 and 2 are correlated to “Document 1”, pages 3 and 3 are correlated to “Document 2”, and page 5 is correlated to “Document 3”.

In examples in which the output from VLM engine received at 210 includes a summary of the pages, a brief description of each constituent document, based, for example, on the summaries, and/or a category or classification associated with each constituent document determined from the summaries, may be included in the index generated at 212.

In another example, in which a fifteen (15) page combined document that includes six (6) constituent documents, and the VLM engine was instructed to provide summaries together with the determinations, the following example index may be generated at 212 in which each constituent document is labeled “1” through “6”, a list of the pages included in that constituent document, a description of the constituent document, and a determined category, of classification, of that document is provided:

{
“1”: {
“pages”: [
1,
2
],
“document_description”: “Detailed MRI brain scan report with findings”,
“category”: “radiology”,
},
“2”: {
“pages”: [
3,
4,
5
],
“document_description”: “Pathology report with radiology findings for tissue sample”,
“category”: “pathology”,
},
“3”: {
“pages”: [
6,
7,
8
],
“document_description”: “Pathology report with radiology findings on brain and head”,
“category”: “pathology”,
},
“4”: {
“pages”: [
9,
10,
11
],
“document_description”: “Pathology report with radiology findings for tissue sample”,
“category”: “pathology”,
},
“5”: {
“pages”: [
12,
13,
14
],
“document_description”: “Pathology report with CT scan findings of abdomen”,
“category”: “pathology”,
},
“6”: {
“pages”: [
15
],
“document_description”: “Pathology report on surgical specimen with patient details”,
“category”: “pathology”,
}
}

The index that is generated at 212 may be in any suitable format including, for example, a table, or a list, or an array, or any combination thereof. The index may be generated at 212 as metadata that is associated with the combined document. The index may, for example, added as metadata to the combined document in, for example, a header of the combined document, or may be stored together with, or separate from but in association with, the combined document in a memory, For example, the index may be stored as metadata associated with the combined document in a memory such as, for example the memory 116 of the example client device 102, or a memory of the example document splitting device 106 described previously with reference to FIG. 1, or in a database including, for example, in a document store, such as, for example, the document store 112 of the example database 104 described previously with reference to FIG. 1.

Optionally at 214, a constituent document file is generated for each constituent document utilizing the index that is generated at 212. Generating the constituent document files may be performed by, for example, the splitting the pages of the combined document into separate constituent documents in accordance with the correlation between the pages of the combined documents and the constituent documents set out in the index. Such splitting or segregating of the constituent document may be performed, for example, to perform further processing and analysis, such as for example document splitting, or optical character recognition (OCR), on, for example, only a subset of constituent documents that are relevant. The optional category and/or document description information included in some example indexes may be utilized to determine which constituent documents are relevant for further analysis in a particular context.

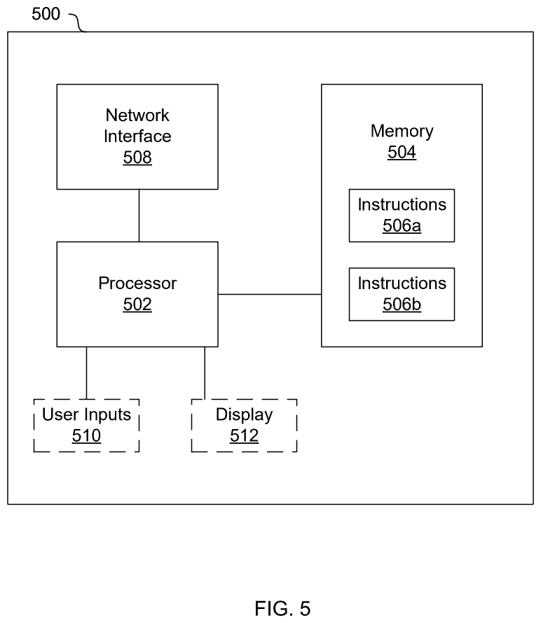

Referring to FIG. 5, a schematic diagram illustrating various physical and logical components of an exemplary apparatus 500 for a document splitting device such as, for example, the example document splitting device 106 described with reference to FIG. 1, in accordance with an embodiment is shown. Although an example embodiment of the apparatus 500 is shown and discussed below, other embodiments may be used to implement examples disclosed herein, which may include components different from those shown. Although FIG. 5 shows a single instance of each component of the apparatus 500, there may be multiple instances of each component shown.

The apparatus 500 includes one or more processors 502, such as a central processing unit (CPU), a microprocessor, an application-specific integrated circuit (ASIC), a field-programmable gate array (FPGA), a dedicated logic circuitry, a graphics processing unit (GPU), a tensor processing unit, a neural processing unit, a dedicated artificial intelligence processing unit, a hardware accelerator, or any other suitable hardware processing circuitry, or combinations thereof. The one or more processors 502 may collectively be referred to as a processor 502.

The apparatus 500 also includes one or more memories 504 (collectively referred to as “memory 504”), which may include a volatile or non-volatile memory (e.g., a flash memory, a random-access memory (RAM), and/or a read-only memory (ROM)). The non-transitory memory 504 may store instructions for execution by the processor 502. In some embodiments, instructions 506 of a document splitting device, a document splitting server, a document decomposer, or a document splitting index generator, as described herein, such as the document splitting device 106, the document splitting server 118, document decomposer 120, and the document splitting index generator 120, of the example system 100, may be stored in the memory 504, and the instructions 506 may be executed by the processor 502 to perform the actions or operations of the methods or processes described herein.

The apparatus 500 may also include one or more network interfaces 508 for connecting to a network, such as the network 110, for communication with, for example, a client device, such as client device 102 of the example system 100, a database, such as the database 104 of the example system 100, and a VLM engine, such as the VLM engine 108 of the example system 100.

The apparatus 500 may optionally include a user input 510 for receiving input from a user of the apparatus 500 and a display 512. The user input 510 may be utilized, for example, for a user to interact with a graphical user interface displayed on the display 512 in order to input a prompt and/or select input documents for a task to be performed by a VLM engine. In this case, the prompt may be received directly from the user, via the user input 510, rather than from a client device.

In some examples, the apparatus 500 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 500) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 604 to implement data storage, retrieval, and caching functions of the apparatus 500.

The components of the apparatus 500 may communicate with each other via a bus. In some embodiments, the apparatus 500 may be a processing system implementing functionality of the document splitting device described herein, such as the document splitting device 106 of the example system 100 previously described with reference to FIG. 1. In some embodiments, the apparatus 500 may be distributed computing system and may include multiple computing devices in communication with each other over a network, as well as optionally one or more additional components. The various operations described herein may be performed by different computing devices of a distributed computing system in some embodiments. In some embodiments, the apparatus 500 may be a cloud computing system or may be a virtual machine provided by a cloud computing system.

Embodiments of the present disclosure enable the document splitting of a combined document that comprises one or more constituent document, facilitating the combined document to be split into its constituent documents.

Embodiments of the present disclosure provide a technical solution to the technical problem of document splitting a document in a more intuitive and reliable manner. Generating overlapping sets of image files that correspond to the pages of the combined document, and inputting the overlapping sets to a VLM engine with instructions to determine whether the image files in the set belong to the same document based on the visual features of the image files leverages multimodal capabilities of the VLM engine, which visual features may provide an more intuitive way to determine when two pages belong to the same document or different documents than focusing solely on the text context. Further, in some examples, the instructions cause the VLM engine to prepare a summary of each image file before making the determination, and/or provide reasons for the determination that is made, which may cause the VLM engine to make its determine utilizing a chain-of-thought prompting that may result in more accurate determinations, and may improve the reliability of the determinations because a user can see how the VLM engine arrived at its determination, and which reasoning may be utilized to retrain the VLM engine when errors occur in order to improve the determinations made by VLM engine over time.

Embodiments of the present disclosure provide an improvement in the functioning of a computer system that is utilized to perform document splitting by enabling more accurate and more reliable document splitting by enabling a chain-of-thought prompting to be performed by a VLM engine during the document splitting process, and by instructing a VLM engine to utilize the visual features, and not just the text content, when performing document splitting, as well as, in some examples, causing the VLM engine to generate summaries of the input pages or image files and/or provide reasons for the determinations that are made by the VLM engine.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

As used in the present disclosure, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in the present disclosure, the term circuitry also covers an implementation of merely a hardware circuit or processor (or multiple processors) or portion of a hardware circuit or processor and its (or their) accompanying software and/or firmware.

The functions, processes, and operations described herein may be performed in a different order, or may be performed concurrently with each other, or a combination thereof. Furthermore, one or more of the functions, processes, and operations may be optional or may be combined. It will be appreciated that the flow diagram shown in FIG. 2 and the various embodiments described with reference to FIG. 2, are examples only. Various operations and processes depicted therein may be omitted, may be reordered, may be combined, or a combination of reordered and combined.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method for performing document splitting on a combined document file, the method comprising:
receiving the combined document file comprising two or more pages that correspond to one or more constituent documents;
for each page of the combined document file, generating an image file that includes the contents of the page;
generating a sequence of overlapping sets of image files, each set including N image files;
inputting each set of N image files to a multimodal vision-language model (VLM) engine with a prompt that instructs the VLM engine to determine whether the N image files in the set belong to a same document or to different documents based on the visual features of the image files included in the set;
for each set of N image files, receiving from the VLM engine an output that indicates whether the N image files belong to the same document or to different documents; and
generating an index that correlates each page of the combined document file to a corresponding one of the one or more constituent documents based on the outputs from the VLM engine associated with the overlapping sets.

2. The method according to claim 1, wherein:
the prompt instructs the VLM engine to generate a summary of each image in the set of N images prior to determining whether the N images in the set belong to a same document or to different documents, and instructs the VLM engine to determine whether the N images in the set belong to the same document or to different documents based on the summary; and
receiving the output from the VLM engine comprises receiving, for each set of N images, the summary of each image in the set.

3. The method according to claim 1, wherein:
the prompt instructs the VLM engine to generate reasons for the determination whether the N images in the set belong to the same document or to different documents; and
receiving the output from the VLM engine comprises receiving, for each set of N images, the reasons.

4. The method according to claim 1, wherein the prompt instructs the VLM engine to determine whether the N images in the set belong to the same document or to different documents based on text content of the images of the set.

5. The method according to claim 4, wherein the prompt instructs the VLM engine to focus on the visual features of the image more than on the text content.

6. The method of claim 4, wherein the prompt instructs the VLM engine to focus on one or more identifiers included in the text content.

7. The method of claim 1, wherein the prompt instructs the VLM engine to focus on the visual features of one or more of font-style, formatting, style of writing, or table format.

8. The method of claim 1, further comprises grouping the sets of N images into sequential, overlapping batches, each batch including K sets of N images, and wherein inputting each set of N images to the VLM engine comprises iteratively inputting each batch of K sets.

9. The method of claim 8, wherein K is greater than 1 and less than or equal to 10.

10. The method of claim 1, wherein N=2, and the sequential sets overlap by one (1) image.

11. An apparatus for performing document splitting on a combined document file, the apparatus comprising:
at least one processor;
at least one memory storing instructions, wherein when the instructions are executed by the at least one processor, cause the apparatus to:
receive the combined document file comprising two or more pages that correspond to one or more constituent documents;
for each page of the combined document file, generate an image file that includes the contents of the page;
generate a sequence of overlapping sets of image files, each set including N image files;
input each set of N image files to a multimodal vision-language model (VLM) engine with a prompt that instructs the VLM engine to determine whether the N image files in the set belong to a same document or to different documents based on the visual features of the image files included in the set;
for each set of N image files, receive from the VLM engine an output that indicates whether the N image files belong to the same document or to different documents; and
generate an index that correlates each page of the combined document file to a corresponding one of the one or more constituent documents based on the outputs from the VLM engine associated with the overlapping sets.

12. The apparatus according to claim 11, wherein:
the prompt instructs the VLM engine to generate a summary of each image in the set of N images prior to determining whether the N images in the set belong to a same document or to different documents, and instructs the VLM engine to determine whether the N images in the set belong to the same document or to different documents based on the summary; and
the instructions, when executed by the at least one processor, cause the apparatus to receive the output from the VLM engine comprise instructions that, when executed by the at least one processor, cause the apparatus to receive, for each set of N images, the summary of each image in the set.

13. The apparatus according to claim 11, wherein:
the prompt instructs the VLM engine to generate reasons for the determination whether the N images in the set belong to the same document or to different documents; and
the instructions, when executed by the at least one processor, cause the apparatus to receive the output from the VLM engine comprise the instructions that, when executed by the at least one processor, cause the apparatus to receive, for each set of N images, the reasons.

14. The apparatus according to claim 11, wherein the prompt instructs the VLM engine to determine whether the N images in the set belong to the same document or to different documents based on text content of the images of the set.

15. The apparatus according to claim 14, wherein the prompt instructs the VLM engine to focus on the visual features of the image more than on the text content.

16. The apparatus of claim 14, wherein the prompt instructs the VLM engine to focus on one or more identifiers included in the text content.

17. The apparatus of claim 11, wherein the prompt instructs the VLM engine to focus on the visual features of one or more of font-style, formatting, style of writing, or table format.

18. The apparatus of claim 11, wherein the instructions, when executed by the at least one processor, further cause the apparatus to group the sets of N images into sequential, overlapping batches, each batch including K sets of N images, and
wherein the instructions, when executed by the at least one processor, cause the apparatus to input each set of N images to the VLM engine comprise instructions that, when executed by the at least one processor, cause the apparatus to iteratively inputting each batch of K sets.

19. The apparatus of claim 18, wherein K is greater than 1 and less than or equal to 10.

20. The apparatus of claim 11, wherein N=2, and the sequential sets overlap by one (1) image.
